(19) United States
(12) Patent Application Publication
(10) Pub. No.: US 2006/0215990 A1
(43) Pub. Date: Sep. 28, 2006

(54) Multi-user PVR

(75) Inventor: Robert C. Proebstel, Beaverton, OR (US)

Correspondence Address: RICHARD C. CALDERWOOD, 2775 NW 126TH AVE, PORTLAND, OR, 97229-8381, US

(73) Assignee: Stexar Corp.

(21) Appl. No.: 11/073,167

(22) Filed: Mar. 4, 2005

(51) Int. Cl. H04N 5/91

(52) U.S. Cl. 386/83

(57) ABSTRACT

A multi-user video recorded which provides filtering of the recorded program and/or electronic program guide on a user-by-user basis. Users can be prevented from seeing specified channels, programs, etc. in the EPG, and/or from viewing them. Users can be prevented from seeing and/or watching programs that other users have recorded on the video recorder.

### BACKGROUND OF THE INVENTION

1. Technical Field of the Invention

This invention relates generally to video recorders for televisions, and more specifically to a video recorder having multi-user capability.

2. Background Art

FIG. 1 illustrates a conventional television system. The system includes a video display, which is commonly a television set. The system also includes a personal video recorder (PVR) which is coupled to provide an input signal to the video display and which receives a video signal from a video source such as a cable television service provider, a satellite television service provider, the internet, or the like. The PVR also receives an electronic programming guide (EPG) from an EPG source such as the television service provider or an online EPG provider such as Tivo, and stores the EPG data in an EPG storage or memory.

The PVR includes a tuner which, under the control of a channel selector, selects one of a plurality of different channels of video signal from the video source. The output of the tuner is provided to the video display device for real-time viewing. The output of the tuner is typically also provided to an encoder which encodes the video signal into some predetermined format such as MPEG-2, which is then recorded on a storage device such as a hard disk.

The user can provide selection criteria, instructing the PVR which programs to record to the storage device for subsequent playback. For example, the user can specify that the PVR should record all motorcycle races, and all movies in which Steve McQueen appears, and all new episodes (but not reruns) of the “Two Wheel Tuesday” series on Speed Channel, and any program which airs on channel 150 between 1 pm and 3 pm on Sundays. The PVR includes a search engine which searches the EPG data in the EPG storage.

The PVR includes a user interface through which the user can enter selection criteria, switch to a specific channel, browse the EPG, look at the list of previously-recorded programs which are available on the storage device, and so forth. When the user selects one of the previously-recorded programs, the PVR's playback control switches the operation of the PVR so that, instead of displaying live television, it starts displaying the selected program.

The user can then rewind, fast forward, pause, stop, delete, etc. the selected program as he sees fit. Typically, the PVR's search engine and recording control remain active during this time, such that if the time comes to record a program, and the user is still watching the previously-recorded program, the new program will be recorded without being viewed in real time. The recording control will have to activate the channel selector to switch the tuner to a different channel, to begin recording the new program, unless the PVR happened to be on that channel already.

Some PVRs and other set-top boxes provide the ability for the user to hide selected channels from being shown in the on-screen EPG. For example, a parent may not want her children to see even the titles of programs on the adult channels. Or, a user may not want to ever see any of the multitude of home shopping channels cluttering up his display. Unfortunately, this ability has not previously been extended to the on-screen list of programs which have been recorded to the PVR.

What is desirable, then, is an improved multi-user PVR which has the ability to provide different EPG data and different recorded program data to each of a plurality of different users.

### BRIEF DESCRIPTION OF THE DRAWINGS

FIG. 1 shows a television/PVR system according to the prior art.

FIG. 2 shows a television/PVR system according to one embodiment of this invention.

FIG. 3 shows a logical flow of one methodology of displaying EPG data for various users.

FIG. 4 shows a logical flow of one methodology of displaying recorded program information for various users.

FIG. 5 shows a logical flow of another methodology of displaying recorded program information for various users.

FIG. 6 is a flowchart showing one embodiment of a method of setting up a multi-user PVR system.

FIG. 7 is a flowchart showing one embodiment of a method of operating a multi-user PVR system.

FIG. 8 shows an interconnected multi-user television network system.

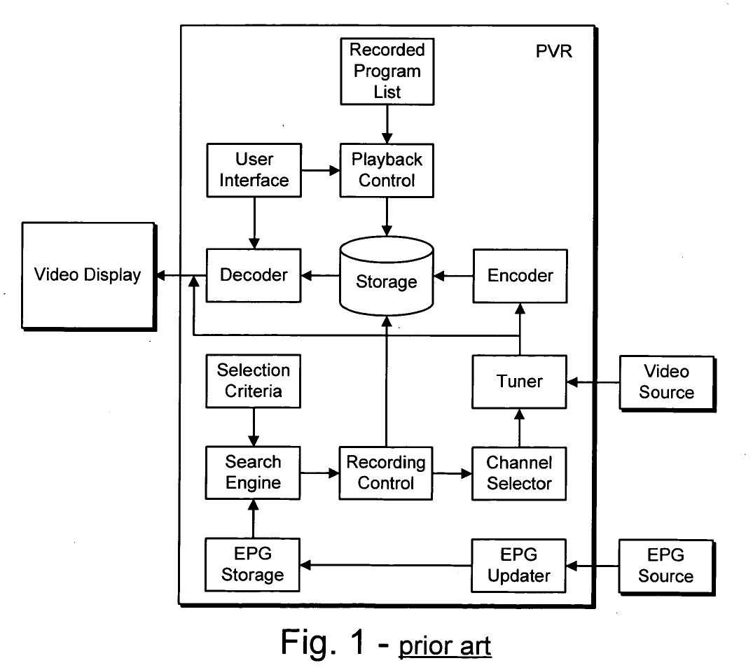

### DETAILED DESCRIPTION

The invention will be understood more fully from the detailed description given below and from the accompanying drawings of embodiments of the invention which, however, should not be taken to limit the invention to the specific embodiments described, but are for explanation and understanding only.

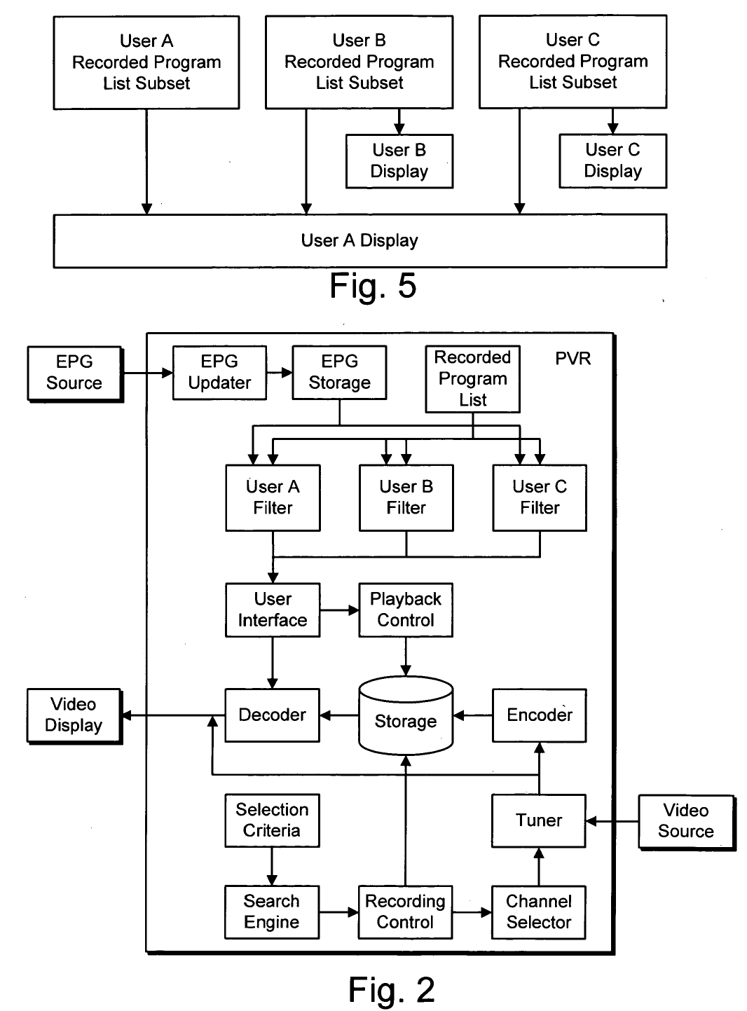

FIG. 2 illustrates a television/PVR system including one embodiment of the enhanced PVR of the present invention. The PVR is coupled to receive a video signal from a video source, to provide a video signal to a video display, and to receive EPG data from an EPG source, as before. The PVR itself includes many of the same components as the prior art PVR, such as a tuner, channel selector, recording controller, search engine, selection criteria memory, video encoder and decoder, storage device, and playback controller.

The new PVR is enhanced with the addition of multi-user functionality. The PVR includes memory for storing filter parameters for each of a plurality of users (A, B, and C in the example shown). Each user's filter controls which portions of the EPG he is allowed to view and/or select. Each user's filter also controls which of the recorded programs on the storage device he is allowed to playback, or even to view by title.

For example, User A may be the parent or superuser, whose filter imposes no restrictions on her. User B may set his filter to omit all shopping channels from the on-screen EPG. User A may set User B's filter to hide all pay-per-view events or to at least prevent them from being selected, because User B has a habit of running up the family's cable bill by watching too many pay-per-view boxing matches. In order to order a pay-per-view boxing match, User B may have to get his wife to enter a one-time permission code or a reuasable password. User C may be a child whose filter prevents him from seeing even the titles of any adult programs. User B may set User C's filter to block all content, rendering the television essentially useless, during weekday homework hours. User A may set her filter to show all available programming from the EPG, but to hide all of User B's pre-recorded motorcycle races when User A views the list of programs which have been recorded to the PVR hard disk. User A may set User C's filter to only show recorded programs which have been recorded by User C (or pursuant to selection criteria specified by User C), so User C can't monitor which programs User A is recording.

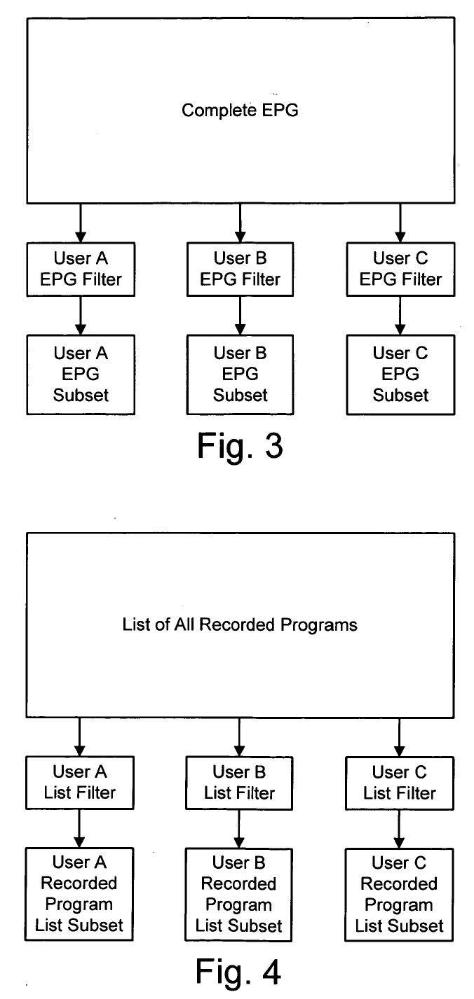

FIG. 3 illustrates one methodology of displaying EPG data for various users. The PVR stores a complete set of EPG data. To display EPG data for User A, the PVR applies the EPG Filter criteria that have been programmed for User A, and displays a filtered subset of the EPG for viewing by User A. To display EPG data for User B, the PVR applies the User B filter criteria and displays the resulting subset. And to display EPG data for User C, the PVR applies the User C filter criteria, and so forth.

FIG. 4 illustrates one methodology of displaying recorded program information for the various users. In this embodiment, the PVR maintains a master list of all recorded programs. When User A enters a request to view the recorded program information (e.g. a list of what has been recorded), the PVR applies the List Filter criteria that have been programmed for User A, and displays the resulting subset for viewing by User A. When User B makes a request, the PVR applies the User B filter criteria, and so forth.

FIG. 5 illustrates another methodology of displaying recorded program information for the various users. Rather than maintaining a master list, the PVR maintains separate lists of recorded programs for each user. When a “junior” user such as User B or User C makes a request to see the list, the PVR simply displays the list of programs which have been recorded for that user. But when the “superuser” User A makes a request to see the list, the PVR coalesces all users' lists and presents a rolled-up list of everything that has been recorded by any user. In some such embodiments, the PVR may annotate the displayed list to indicate which users recorded which programs, to enable User A to provide supervision and guidance of the other users' viewing habits.

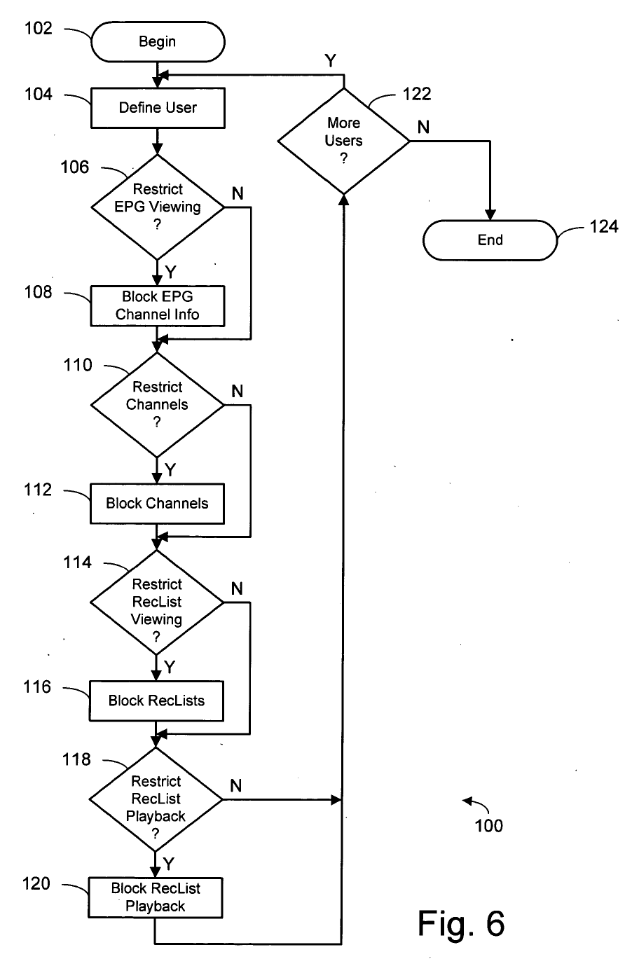

FIG. 6 illustrates in more detail one method (100) of setting up a PVR for use by multiple users. The method begins (102) when the programmer (typically the superuser) defines (104) a user, such as by giving the user a screen name and an icon or avatar. If (106) the programmer indicates that this user should have a restricted ability to view the EPG, the PVR sets (108) this user's EPG filter to block specified channel information.

If (110) the programmer indicates that particular channels or categories of channels should be omitted from the EPG when this user views the EPG, the PVR adds (112) these restrictions to the user's EPG filter criteria. In addition to the channel-specific filtering, the programmer can also specify that any program with particular words in its title or description should be hidden from this user, such as any program with “sex” or “discretion” or “Howard Stern”.

The programmer can specify whether a program should be entirely hidden from the user, or whether the user can see the program in the EPG but cannot select the program for viewing or recording. This enables the user to know about the program and ask the superuser to enable viewing or recording of the program.

If (114) the programmer indicates that the recorded program list should be restricted for this user, the PVR sets (116) the user's recording list filter criteria accordingly. For example, the programmer may wish to specify that the user can only see which programs have been recorded by the user himself, and not any programs that other users have recorded. Or, the programmer may wish to specify that the user can see programs that any user has recorded, except e.g. soap opera programs that the superuser records.

If (118) the programmer indicates that the user's ability to play back items from the recorded program list should be restricted, the PVR adds (120) these restrictions to the user's recorded program filter criteria accordingly. For example, the programmer may wish to specify that the user can see that the superuser has recorded a bunch of hockey games, but not enable the user to watch them himself without the superuser enabling the playback.

If (122) the programmer indicates that there are additional users to be set up, the same steps are repeated for each subsequent user, until there are no more users to set up and the method ends (124).

In one embodiment, the administrator may clone the settings of an existing user and modify them for use with a new user.

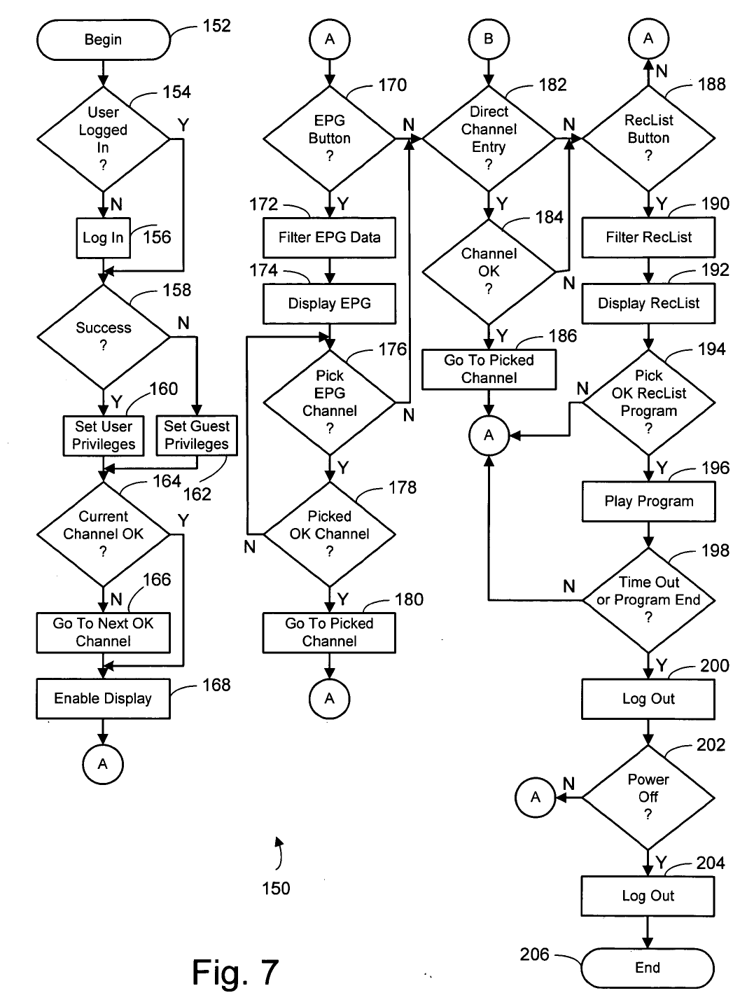

FIG. 7 illustrates one method (150) of operating a multi-user PVR. The method begins (152) when the PVR is powered up or rebooted. When the PVR receives an action request such as when the user presses a button on the remote control, the PVR checks (154) whether the user is logged in, meaning whether the PVR knows which user is making the request. If not, the PVR guides (156) the user through the log in process, typically by having the user select his name from a list of users or a group of icons or avatars, and by entering his password. The password does not necessarily have to be limited to alpha or alphanumeric characters, but, instead, can be a user- or supervisor-specified sequence of remote control keys. For example, a login password may be the sequence:

<play><play><channel up><5><volume down>

If (158) the login is successful (after one or more tries), the PVR sets (160) itself to use that user's privileges such as his EPG filter criteria and recorded list filter criteria. Otherwise, the PVR sets (162) itself to use a predetermined set of guest privileges. The guest privileges can be set by the superuser, or they can be factory defaults. The guest privileges might, for example, prohibit seeing or watching any programs from any user's recorded program list, and block all pay-per-view and adult channels and any movies rated “R” or worse, such that the guest privilege level would be suitable for babysitters and other occasional visitors who do not merit their own user accounts. Alternatively, the guest privileges might enforce all restrictions that have been placed upon any users; this prevents a user from circumventing his restrictions by simply failing to correctly log in.

Once the user is logged in as guest or otherwise, the PVR checks (164) whether the currently-selected channel is allowed under the user's filter criteria. If not, the PVR switches (166) to an approved channel such as the numerically next higher channel which is not restricted, or to a default channel, or even to a blank display. Only then is the television's screen enabled (168) or, alternatively, does the PVR output a video signal to the television set.

If (170) the user presses the EPG button on the remote or on an on-screen menu, the PVR applies (172) the user's EPG Filter criteria before displaying (174) the EPG on screen. If (176) the user selects a channel or program from the EPG, and if (178) that channel or program passes the user's viewing filter criteria, the PVR switches (180) its tuner to the selected channel.

If (182) the user directly enters a channel without going through the EPG, and if (184) that channel and program pass the user's viewing filter criteria, the PVR switches (186) its tuner to that channel.

If (188) the user presses the button or menu item to display the list of recorded programs available for playback (RecList), the PVR applies (190) that user's RecList filter criteria and displays (192) the resulting list of recorded programs. If (194) the user selects a program which passes his viewing filter criteria, the PVR plays (196) that program.

In order to prevent a junior user from accidentally being enabled to watch a previously-logged-in senior user's recorded or live programs, the PVR maintains a watchdog timer that counts down either from the time that the validly-logged-in user logged in (or, alternatively, since the last command he entered). If (198) the watchdog timer times out, the PVR logs the user out (200), forcing him to log in again if he wants to continue viewing programs. Optionally, the user can be automatically logged out (198) at the end of viewing a recorded program and/or a live program.

If (202) the user powers off the PVR (or, optionally, the television), the PVR logs the user out (204), and the method ends (206).

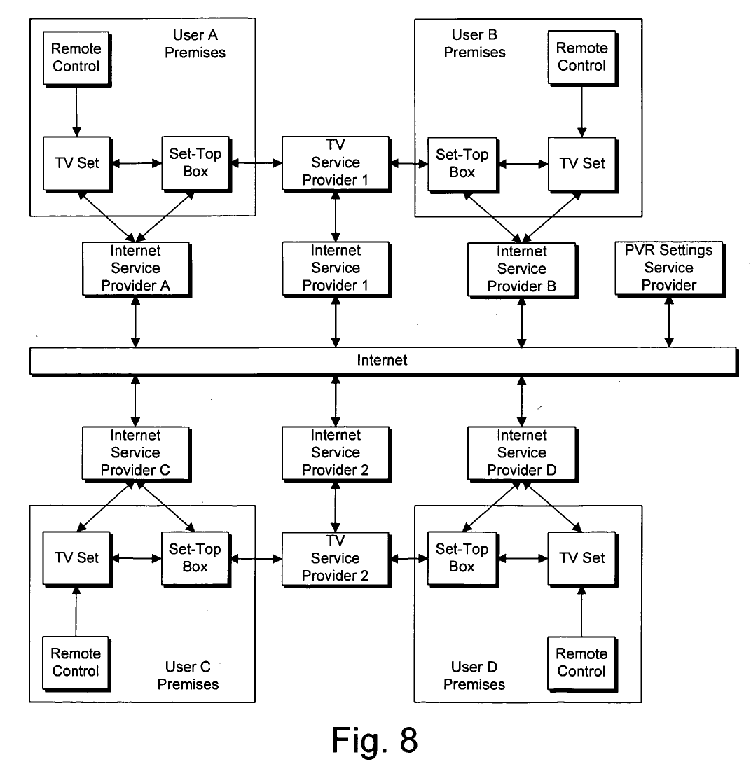

FIG. 8 illustrates a multi-user environment in which another embodiment of this invention may be practiced. The environment includes a plurality of television users (represented by user premises A through D) each having a television set and a set-top box coupled to receive television programming from one of a plurality of television service providers. Optionally, each user's PVR (whether embedded in the television set or in the set-top box or in a stand-alone component) is coupled to the internet via an internet service provider. The television service providers themselves may be coupled to the internet via internet service providers.

Rather than each user or superuser having to manually program each set of selection criteria, filters, and so forth, the various users (at different premises) may share selection criteria, filters, and such with each other. If they are connected to the same television service provider, the sharing may take place within that provider's television network. Otherwise, the sharing may take place over the internet. Optionally, a separate PVR settings service provider may provide a variety of pre-packaged PVR settings which the users may copy and modify. In one embodiment, a user may publish his PVR settings for anyone to copy. In another embodiment, the user may publish his PVR settings subject to e.g. password access such that only a limited group of other users can copy them. In one embodiment, the PVR settings service provider performs this exchange. In some such embodiments, the PVR settings service provider performs an aggregation function, such that a user can subscribe to receive settings from e.g. the 35^{th} percentile most conservative settings in his geographic area, or to receive settings which are the average of all users within his user group. A user group may be e.g. a collection of people who attend the same church and are thus likely to have the same general value system and the same general disposition toward what constitutes a suitable program for an eleven-year-old to watch.

### CONCLUSION

When one component is said to be “adjacent” another component, it should not be interpreted to mean that there is absolutely nothing between the two components, only that they are in the order indicated.

The various features illustrated in the figures may be combined in many ways, and should not be interpreted as though limited to the specific embodiments in which they were explained and shown.

Various conventional PVR details such as how the PVR searches through the EPG finding programs that are to be recorded, how the PVR manages its limited storage, how the PVR prioritizes between conflicting recordable programs, and so forth, have all been omitted here, as they are well understood by those in the art and their disclosure would unnecessarily obscure the teaching of the present invention.

While the invention has been described in terms of a PVR, it may also be practiced in the context of a set-top box which does not necessarily include PVR recordable functionality, or it may be practiced in the context of the television set itself.

Those skilled in the art having the benefit of this disclosure will appreciate that many other variations from the foregoing description and drawings may be made within the scope of the present invention. Indeed, the invention is not limited to the details described above. Rather, it is the following claims including any amendments thereto that define the scope of the invention.

What is claimed is:

1. A video recorder for use in receiving and recording video programs from a video source and displaying the video programs on a video display, the video recorder comprising:
a tuner for receiving the video programs from the video source;
means for specifying which ones of the video programs to record;
a storage medium for recording the specified video programs;
means for displaying a list of the recorded video programs;
means for selecting a program from the list;
means for transmitting the selected program to the video display; and
means for causing the means for displaying the list to display only a subset of a complete list of recorded programs.

2. The video recorder of claim 1 wherein the means for causing comprises:
means for maintaining a plurality of filters each corresponding to a respective one of a plurality of users of the video recorder.

3. The video recorder of claim 2 wherein the plurality of filters comprises:
a plurality of recorded program list filters.

4. The video recorder of claim 2 wherein the plurality of filters comprises:
a plurality of electronic programming guide filters.

5. A method of operating a television system which includes a video display coupled to display programming from a video source, the method comprising:
in response to a user attempting to access a list of programs,
selecting a filter according to an identity of the user;
applying the filter to one of the list of programs and the programs; and
preventing presentation to the video display of a subset of the one of the list of programs and the programs, responsive to the filter.

6. The method of claim 5 wherein:
the one of the list of programs and the programs comprises an electronic programming guide;
whereby the user is prevented by the filter from one of (i) seeing portions of the electronic programming guide on the video display and (ii) watching ones of the programs which are restricted by the filter.

7. A method of operating a television system which includes a video display coupled to display programming from a video source, the method comprising:
receiving a login attempt from a user;
if the login attempt is successful, setting user privileges, otherwise setting guest privileges;
receiving an EPG request from the user to view an electronic programming guide;
in response to the EPG request, filtering the electronic programming guide according to the privileges which were set;
displaying the filtered electronic programming guide; and
preventing the user from selecting a program from the electronic programming guide according to the privileges which were set.

8. The method of claim 7 further comprising:
receiving a RecList request from the user to view a list of recorded programs;
in response to the RecList request, filtering the list of recorded programs according to the privileges which were set;
displaying the filtered list of recorded programs; and
preventing the user from selecting a recorded program from the recorded program list according to the privileges which were set.

9. The method of claim 7 further comprising:
automatically logging the user out.

10. The method of claim 9 wherein automatically logging the user out comprises:
logging the user out at the earlier of an expiration of a timer and an end of a program which the user has watched.

11. The method of claim 7 further comprising:
receiving a direct channel entry request from the user;
determining whether the user would be allowed to select that channel from the electronic programming guide according to the privileges which were set; and
only if the user would be allowed to select that channel, changing a tuner to that channel and displaying a program from that channel on the video display.

12. The method of claim 7 performed within a PVR of the television system.

13. The method of claim 7 performed within a set-top box of the television system.

14. The method of claim 7 performed within a television set of the television system.

15. A method of operating a video recorder, the video recorder coupled to receive programs from a video source and coupled to display a received program on a video display, the method comprising:
receiving a request from a user to view a list of recorded programs;
according to a login identity of the user, preventing the user from viewing a first plurality of programs in the list of recorded programs and permitting the user to view a second plurality of programs in the list of recorded programs.

16. The method of claim 15 wherein:
the first plurality of programs comprises programs recorded by other users.

17. The method of claim 15 further comprising:
preventing the user from recording a third plurality of programs;
permitting the user to record a fourth plurality of programs;
wherein the first plurality of programs comprises programs which were recorded by other users and which would be in the third plurality of programs if the user attempted to record them.

18. The method of claim 15 further comprising:
displaying for the user a list of only those recorded programs which the user would be allowed to record.
